(19) United States
(12) Patent Application Publication
(10) Pub. No.: US 2003/0011741 A1
(43) Pub. Date: Jan. 16, 2003

(54) Combination, a sunglasses and bandanna device

(76) Inventor: Stewart Gong, Elk Grove, CA (US)

Correspondence Address: Stewart Gong, 2816 Buckminster Drive, Elk Grove, CA, 95758, US

(21) Appl. No.: 10/177,842

(22) Filed: Jun. 25, 2002

Related U.S. Application Data
(60) Provisional application No. 60/302,622, filed on Jul. 3, 2001.

(51) Int. Cl. G02C 5/14; G02C 1/00; G02C 11/02

(52) U.S. Cl. 351/111; 351/41; 351/51

(57) ABSTRACT

A pair of sunglasses in which a cloth bandanna is used to fasten and secure the frame of the lenses to a person's head instead of the temple and earpiece. A key ring is inserted into the left hinge hole where the temple is normally attached to the frame of the lenses. A bandanna is secured onto the key ring by wrapping the cloth around the key ring and sewing it together or by using Velcro to secure the bandanna to the key ring. This process of securing the bandanna to the left frame of the lens is also repeated for the right hinge hole. The person wearing the sunglasses secures it by wrapping the two bandannas around their head, cinching the cloth to a comfortable fit and then tying a knot in back of their head.

### FIELD OF THE INVENTION

The present invention relates to a new and novel manner in which to wear sunglasses by wrapping a colorful bandanna around the user's head, providing a stylish alternative to conventional temple and earpiece sunglasses.

### BACKGROUND OF THE INVENTION

Known in the art of securing eyewear such as sunglasses to a person's head are temples and earpieces. A temple is fastened to the outer perimeter of the lens frame by a hinge. A curved section of the temple known as the earpiece fits over the top of a person's ear to secure the sunglasses. Between the two lenses of the frame is a curved piece known as the bridge. The frame of the lenses rest on the bridge of a pcrson's nose.

The invention provides a novel, stylish and fun way to secure a pair of sunglasses to a person's head. With a bandanna worn around a person's head, the invention makes the wearer look more dashing. The convention of wearing sunglasses using a temple and earpiece appears stodgy by comparison.

Conventional sunglasses that use a temple and earpiece tend to become dislodged when playing active sports. By tying the sunglasses to a person's head with a bandanna, the invention prevents sunglasses from falling off the user's head while playing active sports.

Sunglasses which utilize temple and earpieces to secure the frame generally have narrow temples in which to display a manufacturers logo or name. The invention, which uses a bandanna which is several inches wide, is a able to accommodate logos which are large enough to be seen several feet away, thus providing a more visible logo for manufacturers name placement.

With conventional temple and earpiece eyewear, changing the temple is a difficult process requiring a screwdriver of the proper size. The invention provides an easy and fast way to change bandannas by just unfastening the Velcro which secures the bandanna to the keyring. Therefore a consumer can change the color, logo, look and character of the sunglasses expeditiously with no special tools.

### SUMMARY OF THE INVENTION

It is a principle object of this invention to provide a fun, stylish and novel manner in which to ear sunglasses by fastening the frame of the lenses to the consumers head by utilizing a colorful bandanna, which is tied to the back of the wearers head, in place of the conventional temple and earpiece.

Another object of the invention is to provide interchangeable bandannas, thus providing the consumer with the ability to change the color, logo and appearance and overall character of the eyewear.

A further object of the invention is to secure the sunglasses while playing active sports. By tying the bandanna in a knot behind the consumers head, the eyewear will not become dislodged and fall off.

Still another object of this invention is to provide a space for large and colorful logos to be printed on the bandannas so that manufacturers can display their company logos prominently. It is a current trend that consumers have a propensity to display manufacturer logos n their clothing and sports gear.

### BRIEF DESCRIPTION OF THE DRAWINGS

FIG. 1 is a three quarters perspective of the sunglasses and bandanna combination.

Before explaining the disclosed embodiment of the present invention in detail, it is to be understood the invention is not limited in its application to the details of the particular arrangement shown, silence the invention is capable of other embodiments. Also, the drawings are designed as an illustration only and not as a definition of the limits of the invention.

### DESCRIPTION OF THE PREFFERED EMBODIMENT

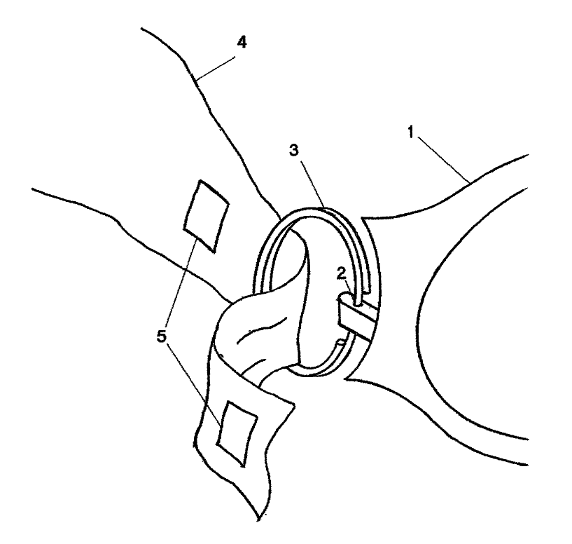

Referring to FIG. 1 is shown a pair of sunglasses and bandanna combination. The sunglasses and bandanna combination includes a frame (1) which has a hinge hole (2) into which a keyring (3) is inserted. The bandanna (4) is fastened onto the keyring (3) by way of two Velcro pieces (4). The process is repeated for the opposite side of the sunglasses and bandanna combination.

Although the present invention has been described with reference to the preferred embodiments, numerous modifications and variations can be made and still the result will come within the spirit and scope of the invention. No limitations with the respect to the specific embodiments disclosed herein is intended or inferred.

I claim:

1. A sunglasses and bandanna combination comprising:
a key ring which is inserted into the hinge hole where the temple is normally attached to the frame a bandanna made of cotton, silk or other cloth material about 20 inches in length and approximately 2 to 3 inches wide is fastened to the key ring via the use of Velcro strips or sewn onto the key ring.

2. A sunglasses and bandanna combination in claim 1, wherein the bandannas are interchangeable because they are attached to the keying via Velcro strips. A consumer can therefore change the look, color and style of the bandanna.

3. A sunglasses and bandanna combination in claim 1, wherein the bandannas can be silk-screened with various manufacturers' logos or different colors and designs.

4. A sunglasses and bandanna combination in claim 1, wherein the bandanna serves to prevent the sunglasses from dislodging during active sports activities because the bandanna is tied to the back of the consumer's head, thus securing the sunglasses firmly and comfortably.
